(19) United States
(12) Patent Application Publication
(10) Pub. No.: US 2005/0034355 A1
(43) Pub. Date: Feb. 17, 2005

(54) Cannonballs for use with downriggers

(76) Inventor: Carl Arthur Dzenis, Wiarton (CA)

Correspondence Address: Ralph A. Dowell of DOWELL & DOWELL P.C., 2111 Eisenhower Ave., Suite 406, Alexandria, VA, 22314, US

(21) Appl. No.: 10/762,561

(22) Filed: Jan. 23, 2004

Related U.S. Application Data
(60) Provisional application No. 60/441,807, filed on Jan. 23, 2003.

(51) Int. Cl. A01K 91/08

(52) U.S. Cl. 43/43.13

(57) ABSTRACT

The present invention is a cannonball for use in association with downriggers. The cannonball has a generally egg shaped body. The body has a front, a back, a center line, a top portion and a bottom portion. The slopes of the top portion from the center line to the front and the back are greater than the slopes of the bottom portion from the center line to the front and the back.

### CROSS REFERENCE TO RELATED PATENT APPLICATION

This patent application relates to U.S. Provisional Patent Application Ser. No. 60/441,807 filed on Jan. 23, 2003 entitled CANNONBALL FOR USE WITH DOWNRIGGERS which is incorporated herein by reference.

### FIELD OF THE INVENTION

This invention relates to a cannonball and in particular cannonballs that are used in association with downriggers.

### BACKGROUND OF THE INVENTION

Downrigging sport fishing has become tremendously popular since it was introduced to the Great Lakes in Canada and United States over the past 30 years. While technology has kept pace in the development of other equipment associated with the sport, i.e. boats, motors, marine electronics, rods, reels, etc., the lowly cannonball was left in its original primitive form. There has been virtually no new developments in the design of downrigging cannonball products for the past thirty years. Two primary types of cannonballs dominated the market; the round cannonball, and the pancake shaped cannonball. For the most part, cannonballs are made of lead or lead alloys and usually have some type of protective coating. They weigh an average of 10 lbs.

Essentially, the primary function of a downrigger cannonball is to serve as a weight to lower one's fishing lure into the water to a specific depth where salmon and various species of trout are known to congregate. This is accomplished by using an apparatus known as a downrigger. The downrigger is a simple device whereby a spool and extension arm are fashioned together, and by means of a clamping mechanism, it can be mounted on the top edge of a transom or the gunwales of a boat. The spool contains an ample supply of thin wire (usually stainless steel fibres) to which the downrigger cannonball is attached. The cannonball can then be lowered into the water from the back of the boat by means of a manual crank on the spool or an electronic DC motor. This is all done while the boat is moving forward at a rate of speed usually between 1 and 4 knots. Each cannonball has some type of release mechanism attached to it that is designed to clamp onto one's fishing line as the cannonball is being lowered into the water. The mechanism is similar to a spring loaded clothes peg. A short wire connects this release mechanism to the cannonball. The fisher attaches a selected lure to the fishing line then throws the lure into the water behind the boat releasing more line as the boat travels forward. Once the desired length of fishing line is deployed, the fishing line is attached to the cannonball by means of this release mechanism (often called an off-shore release clip). Sometimes, fishers will use elastic bands to attach their fishing lines to the cannonballs. The cannonball is then lowered into the water to a prescribed depth with the fishing line and lure in tow.

Once all this is done, the fisher is now engaged in the type of fishing known as “downrigging”, essentially trolling for salmon or trout. The object of course is to troll in an area and depth where the fish are known to congregate and entice the fish to strike at the lure. Once the fish bites the lure and tugs at it, the release mechanism sets the fishing line free from the cannonball and the fisher then begins the task of reeling the fish into the boat. Salmon boats come in all shapes and sizes and can have between 1 and 10 downriggers secured to the back of the boat.

The above describes the primary function of the downrigger cannonball, however, there are a number of other considerations. The cannonball must travel in a straight line while it is being towed along and submerged behind the boat. This is known as “tracking”. It is especially important when more than one downrigger is being used. A mistracking cannonball will cause the cable to become entangled with the other cables resulting in damage to the fine strands of wire in the cables. Once damaged, the cables must be replaced at considerable expense of time and money.

Both the round cannonball and the pancake shaped cannonball actually do track in a straight line. Although there have been numerous attempts at producing and marketing fish shape cannonballs, they all failed because they would not track properly. Subsequently a stigma has been attached to all such efforts. The next big test for all cannonballs is their ability to go around a corner while submerged in water travelling behind a boat. The Great Lakes are huge and the fish are largely few and far between. It is not uncommon for fishers to troll for hours at a time before they even mark fish on their electronic fishfinders. Subsequently when a fisher finally marks some fish, it is most desirable to circle around the area a number of times to try and catch them. Going around a corner poses a big problem for both the round and pancake type of cannonballs.

The round cannonball has a tendency to drag far behind the boat at a sharp angle, mainly because of its large surface area. When the fisher attempts to go around a tight corner, the cannonball will sink to a lower depth or even get caught on the bottom. The fisher must therefore accelerate around the corner to prevent the ball from sinking. Proper depth control is important to salmon fishing, because the fish tend to stay in a narrow horizontal temperature band of water, known as the thermocline. If a cannonball which is in this band of water sinks below this level while the boat is going around a corner, the fisher is unlikely to catch any fish.

Using the round cannonball, fishers must therefore speed up around corners to avoid the sinking cannonball problem.

Speeding up causes another problem, any salmon pursuing the fisher's lure while traveling in a straight line will often break off the chase if it detects a dramatic increase in the speed of the lure.

The pancake styled cannonball was the first major design improvement to the round cannonball. True to its name, it is essentially a round cannonball that has been flattened. They usually have a flat metal tall embedded into the body to serve as a rudder. The fisher was then able to lower the cannonball more accurately to the desired depth without running into a serious drag problem. However, the pancake cannonball has a serious design flaw because it cannot negotiate tight corners without becoming entangled. It is a flat object traveling through water and has a tendency to continue in a straight path while the boat above turns a corner. This will cause the pancake to veer out and actually start to climb in the water because it is now at a sideways angle. It will continue to swing out and climb until it reaches a point where it can no longer sustain its path. In aviation, this is known as stalling speed. Similarly, when a lead pancake shaped cannonball stalls on a wayward trajectory, the results are disastrous. The cannonball will swing back and tangle up and damage all the lines.

To avoid this situation, a fisher using the flat pancake style cannonball is restricted to how fast and tight a turn can be executed. Practically, by the time the fisher makes the long lazy circle back to the point where the fish were originally observed, the fish are usually long gone.

Various fishing tackle manufacturers have experimented with fish shaped cannonballs, however they have all failed. The products mistracked and became frequently entangled and subsequently they have disappeared from the market. Accordingly it would be advantageous to overcome these obstacles and provide the fisher with a few extra performance options that have been demonstrated to improve the likelihood of catching fish. It would be advantageous to provide a cannonball that can be lowered to the desired depth and that allows a consistent trolling speed to be maintained without affecting the trolling depth, even while going around corners. Further, it would be advantageous to provide a cannonball that can be used such that the downrigging boat may execute a tight figure eight pattern without having the lines cross.

### SUMMARY OF THE INVENTION

The present invention is a cannonball for use in association with downriggers. The cannonball has a generally egg shaped body. The body has a front, a back, a center line, a top portion and a bottom portion. The slopes of the top portion from the center line to the front and the back are greater than the slopes of the bottom portion from the center line to the front and the back.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a side view of the cannonball of the present invention;

FIG. 2 is a top view of the cannonball of the present invention;

FIG. 3 is a perspective view of the cannonball of the present invention as viewed from the back and the side;

FIG. 4 is a perspective view of the cannonball of the present invention as viewed from the bottom;

FIG. 5 is a perspective view of the cannonball of the present invention as viewed from the top;

FIG. 6 is a perspective view of an alternate version of th cannonball of the present invention showing a faceted surface and shark teeth;

FIG. 7 is a perspective view of another alternate version of the cannonball of the present invention showing the shark teeth;

FIG. 8 is a perspective view of the cannonball of the present invention showing a hammered chrome finish; and

FIG. 9 is a perspective view of the cannonball of the present invention showing a vinyl finish.

FIG. 10 is a diagram of the present invention showing a plurality of points.

### DETAILED DESCRIPTION OF THE INVENTION

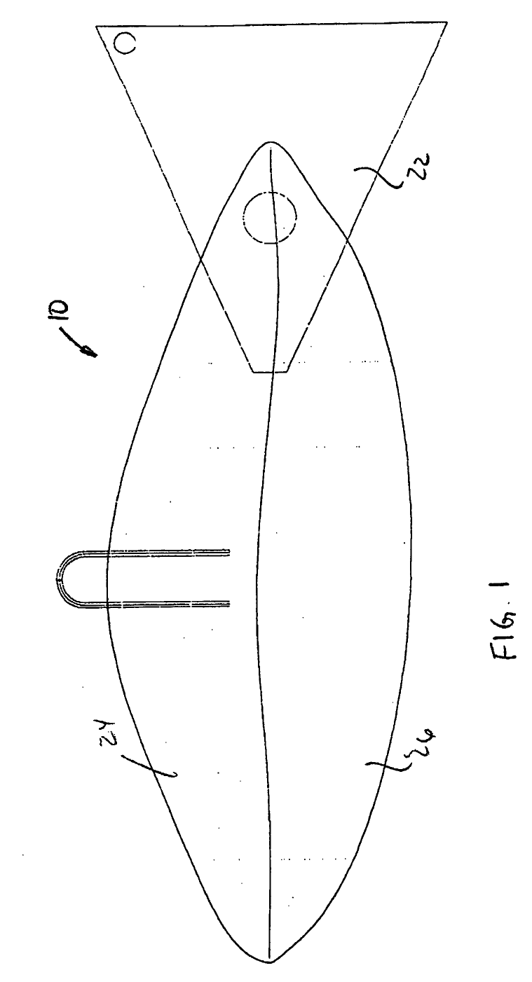

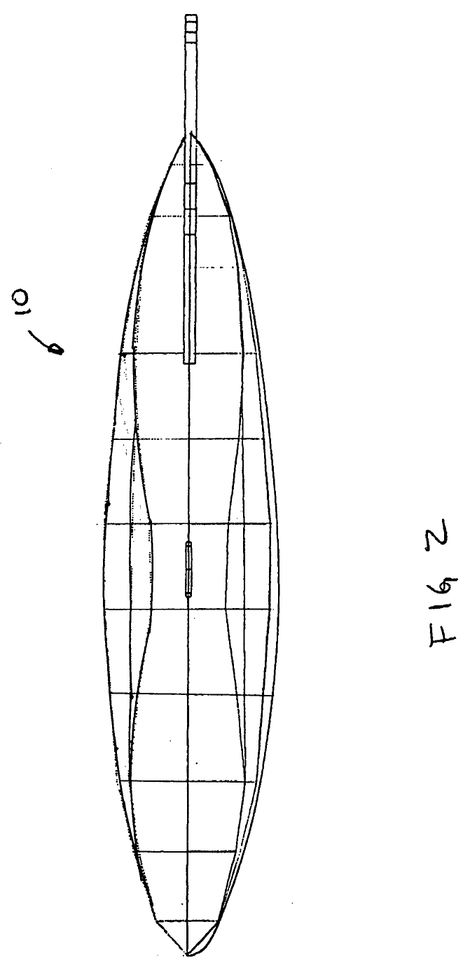

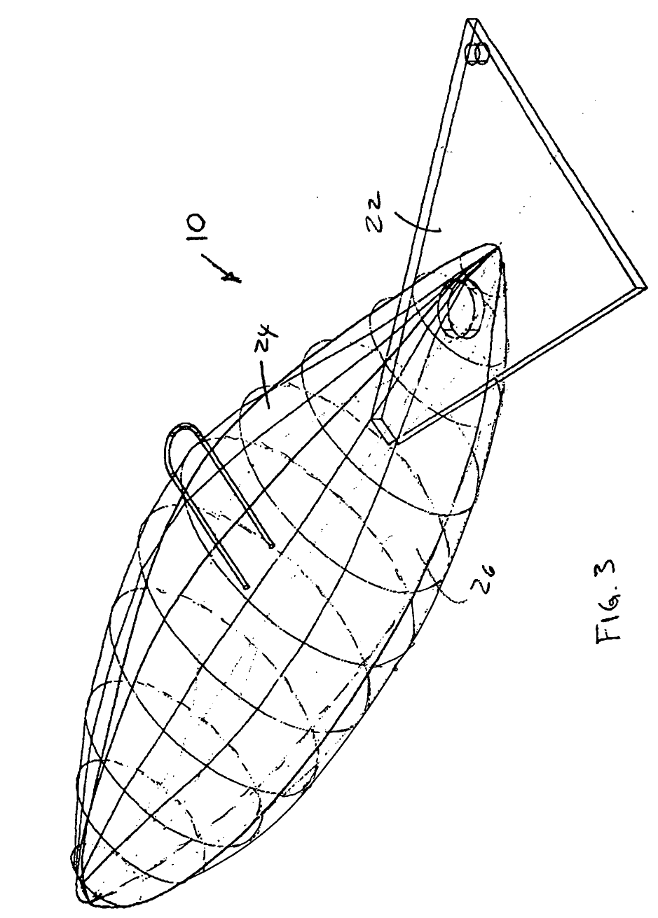

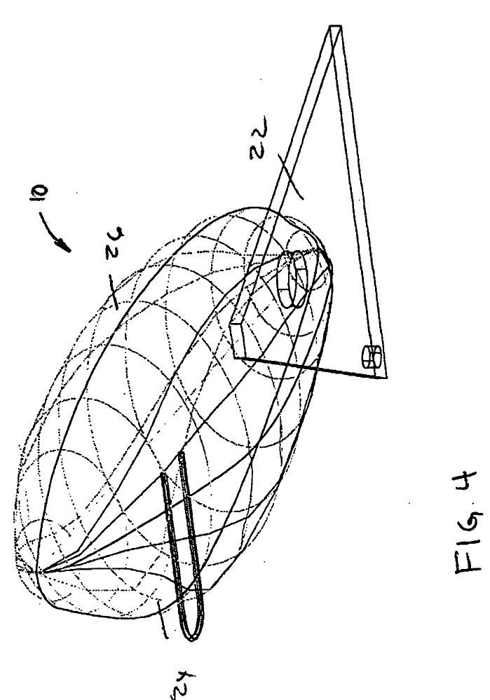

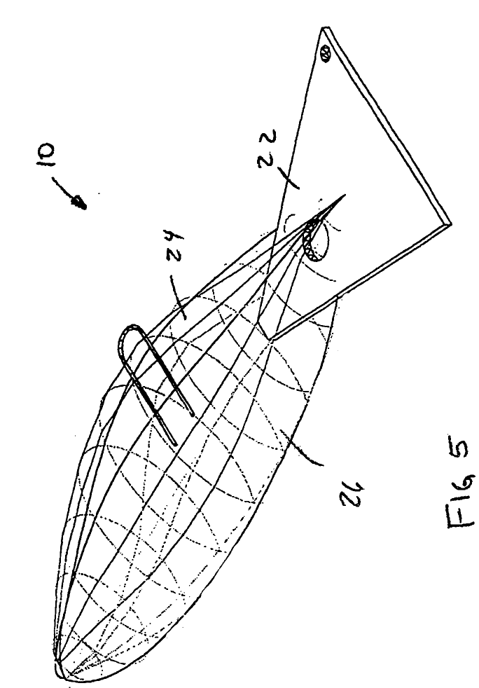

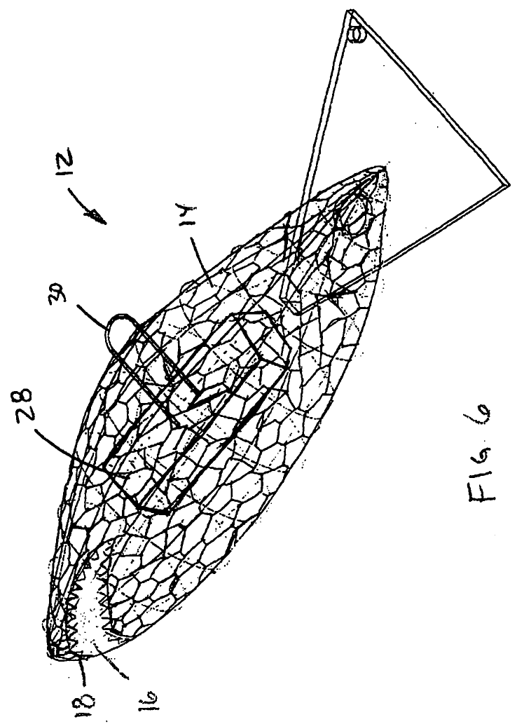

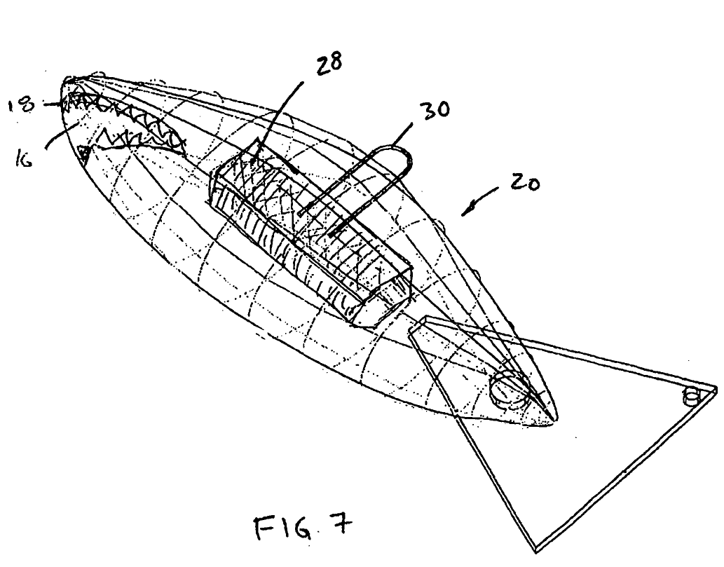

Referring to the figures the cannonball of the present invention is shown generally at 10 in FIGS. 1 through 5. An alternate embodiment of the cannonball of the present invention is shown generally at 12 in FIG. 6. Cannonball 12 has the same shape as cannonball 10 but is covered with a faceted surface 14. In addition the cannonball 12 is provided with a mouth 16 and teeth 18. Another alternate embodiment is shown generally at 20 in FIG. 7 which has the shape and surface treatment of the original cannonball 10 and the mouth 16 and teeth 18 similar to those shown in cannonball 12. The actual design specifications of the cannonball of the present invention are unique and significantly different from any other so called fish shaped downrigger cannonballs. The surface facets and the stylized teeth in the mouth are completely unique to this product.

One obvious benefit of the faceted surface 14 (shown in FIG. 6) is the visibility whereby the facets reflect light in a pattern unique to this product, perhaps resembling the silver scales of the salmon. The facets are not flat surfaces as one might find in a diamond. Each facet is slightly concave having asymmetrical sides around the perimeter. While the ability to reflect light appears to be the main benefit to this design, there is another benefit. The dimpled surface creates a unique sound signature as it travels through the water.

While the fish do not actually hear sound as people do, they are able to detect and identify disturbances in the water. They can distinguish between a motor boat and a school of baitfish. Their curiosity will cause them to investigate for a visual confirmation. It is believed that salmon and trout possess a unique method of object identification which is especially useful in dark or murky water. They have a thin lateral line running the full length of their bodies. It is thought to be some type of sonar like system. They will approach an object and engage in a shuddering sideways movement while curving their bodies in the direction of the object. While this ability has been largely investigated by the scientific community the specific details are not totally understood. The salmon and trout use this ability to identify objects in the water in the absence of light.

Data was collected comparing the present invention with the smooth surface and the present invention with the faceted surface. Catch ratios between the two models were reported. It was determined that using the faceted model caught 10 times as many fish again at depths where light was not an issue. Interestingly, similar testing between round and pancake shaped cannonballs and the present invention determined this invention yielded a substantially higher catch ratio.

Using underwater video cameras, the causes relating to the success of the present invention were indeed revealed. Salmon and trout would come in from the sidelines and intensely investigate the faceted model. They were observed swimming in tight circles around the faceted model of the present invention, frequently engaging in the sideways shuddering move using their lateral line sonar like ability to identify the object. They were also observed to engage in this type of behavior while investigating the model with the smooth surface, however not nearly as intensely as the faceted model.

While salmon and trout are known to use this technique they typically execute the move once or twice and then they usually break off the chase once they determine the identity of the object. In the case of the faceted model of the present invention, the salmon and trout persisted in repeating the cycle of circling around and the presenting lateral line object identification behavior for an unusually long time, in some cases this intense curiosity was observed for periods up to five minutes. Clearly the facets played a major role in the phenomenon.

Without intending to be limited to any particular theory, the sonar-like ability has been scientifically linked to the lateral line on the side of the salmon and trout. A signal is emitted by the fish, it then arches its body in the direction it is anticipating the signal to return from. The salmon is primarily looking for bait-fish to eat and when it cannot see because of lack of light or murky water, it will use this sonar system to identify prey at close rang. The facets on the current invention are concave in shape and serve to confuse the salmon that is investigating the current invention. If the surface is smooth, the salmon will receive an appropriate signal to identify it as a singular object and likely identify it as one of its own kind. In the case of the current invention, when the salmon emits its signal, the beam hits the multifaceted surface on the current invention (each facet in effect is similar to a small satellite receiving dish) and instead of reflecting a signal that the salmon can interpret as a singular object, the current invention reflects hundreds of small signals. The salmon interprets this signal to be a school of small baitfish and persists in an intense chase to find the baitfish. This aspect of the design is believed to be one of the primary reasons why the current invention works as well as it does.

It is believed that this persistent response has never been reported using round cannonballs, pancake shaped cannonballs and other fish shaped cannonballs. It is believed that the combination of all the design attributes found in the present invention are responsible for this most enviable result.

It has been determined that the facets on the sides of the cannonball herein as well as the articulated stylized teeth in the mouth create a vibration or disturbance pattern that will cause the salmon to come from distances beyond visual range to investigate the commotion.

Experiments were conducted using the faceted model and a plastic coated model on very dark nights and running the downriggers at depths where no residual light could possibly reach. Each experiment was conducted without the use of a fishing lure so there would be no overlay of effects. A sonar type fish finder with a three dimensional display that is able to mark fish up to fifty feet on both sides of the submerged cannonball was used. First, when a conventional round downrigger fishing weight was lowered to a depth of one hundred feet and observed, it had no effect on fish as it passed them. The cannonball of the present invention with the faceted surface was then lowered to the same depth. Remarkably, fish that were marked far off to each side were attracted and came over to investigate. It was concluded the disturbance created by the faceted surface of the cannonball must have played a role.

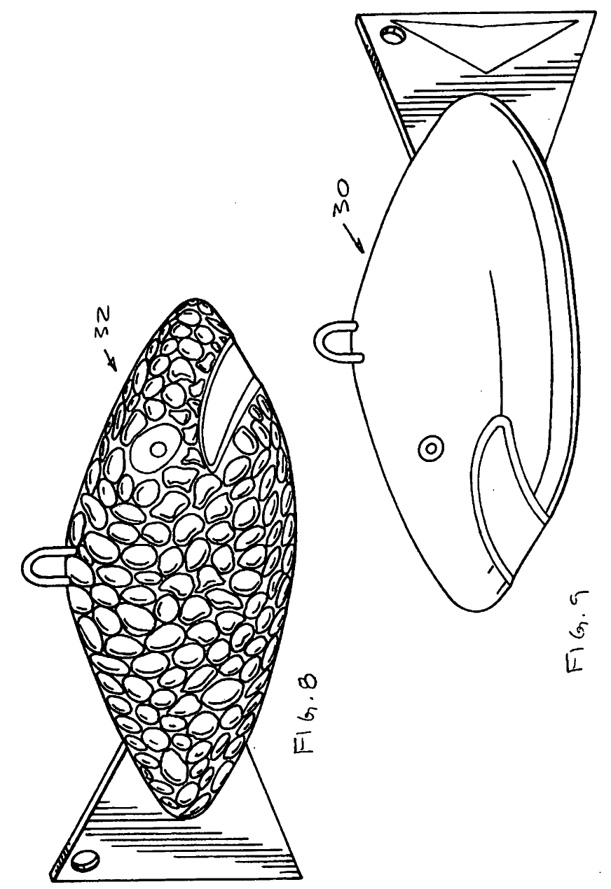

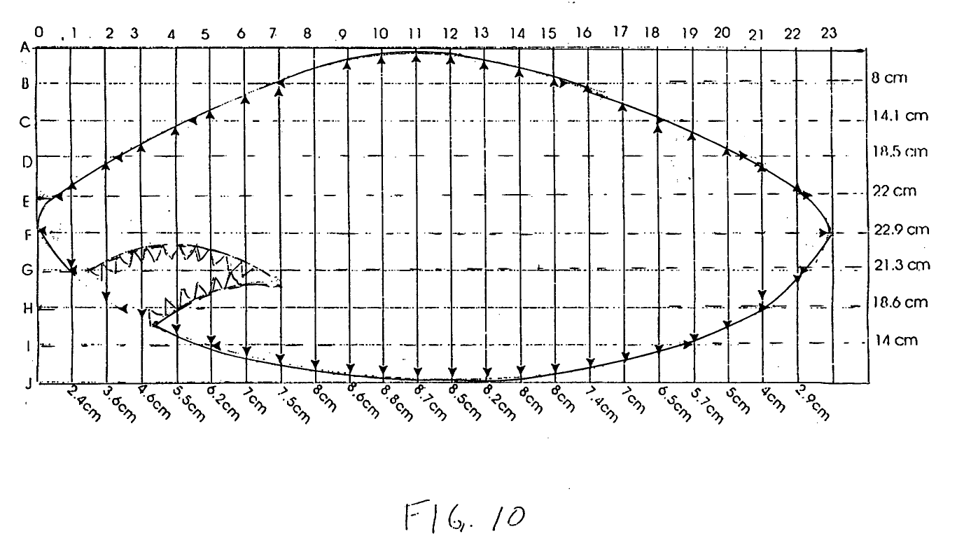

The experiment was repeated with a similar model without the facets having a commercially available vinyl coating. This version of the cannonball of the present invention is specifically shown in FIG. 9 at 30. During the day, fish would come over to investigate only when there was enough light so they could see the profile of a fish. However, at night this model failed to attract any interest on its own. It was then deduced that the facets on the chrome model were responsible for creating a sound signature that served to attract the salmon. A version having a hammered chrome finish is shown in FIG. 8 at 32. Accordingly the vinyl coated version was modified to cause some sort of turbulence as the cannonball traveled through the water. A stylized mouth 16 with large teeth 18 was also added. The late night experiment was repeated with the new model and it was found that fish were then attracted to investigate.

To summarize, there are two basic variations of the cannonball of the present invention; the plain plastic coated model that will be affordable to the average fisher, and faceted model having the chrome finish.

The cannonball of the present invention may also include the stylized shark mouth 18, the reflective chevron tail sticker 22, and the various protective finishes the product is available in. The faceted chrome finish is especially desirable. There is an inlay in the mouth section which is a stylized mouth of a shark.

In the last 30 years since sport salmon fishing has been introduced to the Great Lakes area of Canada and the United States, the primary cannonball has been a round shaped variety and also a pancake shaped cannonball. Manufacturers have attempted to produce fish shaped cannonballs, however because of their designs incorporating fins and various other features that were not hydrodynamically sound, they failed and subsequently faded from the market.

While the idea of using a fish shaped cannonball is not new, to do so successfully has always been the objective. A fish uses its tail for forward propulsion and a cannonball is dragged through the water with a cable attached to a metal loop so the physics applied to the forward motion is substantially different. While at first glance the cannonball of the present invention appears to be the standard shape and form of a fish, it is substantially different. The primary engineering design that makes the cannonball of the present invention work so well is the slope ratio of the top 24 of the fish to the bottom 26 of the fish. The slope on the top 24 of the cannonball herein is much greater than on the bottom 26. The slopes descending from the center line off to the sides are primarily responsible for the cannonball herein being able to track perfectly while it is being towed from a line attached above. This particular slope is an essential element of design of the successful functioning of the cannonball herein and has taken 3 years of experimentation to get a formula that works exactly as this one does.

The third major attribute that distinguishes the cannonball herein from the round and the pancake style cannonball is that it functions as a predator fish decoy. The function of the other cannonballs is to simply lower the fishing lure to the level at which the fish are marked. The cannonball of the present invention functions as a fish decoy by which the salmon and trout are attracted to the downrigger cannonball and they swim along side of it bringing them within proximity to the bait lure.

Regarding the decoy properties of the cannonball herein, a great deal of time and development has gone into the surface coatings. The cannonball of the present invention may have a baked on vinyl coating in a variety of colours. Alternatively, the cannonball has a painted surface similar to the colouration of an actual salmon or trout. Both coating techniques appeal to fishers. The baked on vinyl is much more durable than the painted surface however the realistic painted surface while not nearly as durable as the baked on vinyl seemed to function better at attracting the salmon and trout. The cannonball herein has a chevron style shaped piece of reflective tape on each side of the tail and a realistic reflective eye 34 on each side which has been demonstrated to fool the salmon into thinking it is one of its kind.

Equally the cannonball herein acts as a decoy and is able to fool the baitfish as well. When a cannonball herein travels through a school of baitfish, the school will part to make way for the predators. This sudden partition of the school serves as a massive graphic signal to any other salmon lurking in the area. The salmon know and recognize this sign and then the hunt is on.

There are many species of predator fish that use the technique of corralling schools of baitfish into a tight bunch. They then take turns darting through the school for a feed while the other predators remain stationed on the perimeters to keep the school in a tight group.

The fact that the school of baitfish splits into two leaves the cannonball of the present invention as a decoy in the clearing with a single lure wobbling behind it representing a wounded baitfish. If the cannonball decoy herein was unable to facilitate the scattering of the baitfish the lure would be indistinguishable in a school of up to one million baitfish. It is a well known fact among knowledgeable and experienced fishers that the round and pancake shaped cannonballs do not cause the baitfish schools to panic and head off in separate directions. When a fisher uses a round or pancake cannonball and hits a large school of baitfish, the tips of all the rods shake violently. This is because the fishing lines attached down to the cannonballs are slicing through the baitfish causing the rods to shake. The round and pancake cannonball shapes are actually unnatural objects in the water and have been known to keep salmon at a safe distance which is why a fisher will keep the lure 20-50 feet behind the cannonball.

To summarize the distinguishing features of the cannonball of the present invention, a fisher is able to place the cannonball herein in the thermocline with much more accuracy and control than the round cannonball because it has 60% less surface area. Unlike the pancake cannonball which can be placed within the thermocline, the cannonball herein is able to follow the boat around tight corners and not swing out and cross over. Thirdly, the cannonball herein functions as an excellent decoy which the two other primary types of cannonballs do not do.

The cannonball herein uses a 12 gauge stainless steel or brass tail which is imbedded into the body of the fish unlike most other cannonballs which simply use the lead casting. This is done so that the rudder fin will not become dented or misshaped causing the cannonball to mistrack.

The major problem with hot lead casting is “sink”. Sink is caused by air pockets in the molten lead as it cools. Using conventional lead pouring technology, small pockets of air become trapped in the casting. It is these pockets that cause the casting to become malformed. The minutest deformity in this regard will cause the symmetry of the fish to be seriously affected and cause it to mistrack in the water. The scientific principle involved here is known as Bernoulies principle. If one side of the fish has greater surface area than the other side because of a manufacturing deficiency such as sink in the lead, it will create an area of reduced pressure on the larger side and an area of positive pressure on the smaller surface. This will cause the cannonball to veer out in the direction of the larger surface and then suddenly swing back when it reaches a stalling point. This could potentially cause damage to the prop her as the wires tangle up.

Based on the length, height and width of the fish shaped cannonball it typically weighs in at 10 pounds, give or take an ounce depending on the lead alloy that is available when the product is poured. Preferably cannonballs weighs 10, 12 or 15 pounds. However, cannonballs that range from 8 to 15 lbs having a fish shape that is proportional to the 10 lb model will also work. In other words all the design attributes would simply be scaled to the size the final product weighs in at.

In the preferred embodiment wherein the cannonball weighs approximately 10 lbs the cannonball has the following dimensions. The tail has a back edge that measures 10.3 cm along the back edge. The tail protrudes 7.2 cm from the top-rear portion of the body and 7 cm from the bottom-rear. These measurements are approximately 9.2 cm and 9 cm respectively for the 15 pound model. The tail has a ⅜″ hole in the top corner of the tall being between 0.4 cm and 0.5 cm from the edges of the tail. The tail is 12 gauge stainless steel or brass. Further, the lead portion of the body measures 22.75 cm×8.75 cm×4.5 cm and the entire body of the cannonball, including hook wire and steel tail, measures 26.4 cm×10.cm×4.5 cm.

To counter the sink effect described above a production technique was developed. A small lead core 28 is inserted into the mold before the lead is actually poured. It is suspended in the centre of the mold by the latch-on hook devise and then the lead is poured in. This prevents the lead from cooling in on itself as the central area is occupied by a solid mass. Round cannonballs are not concerned with this because of their hemispheric design. It is the same principle that an egg shell will not implode inwards on itself because of the surface tension on the outside.

Similarity, pancake style cannonballs are stamped into their flat configuration and do not encounter the same problem. The cannonball herein has many curves in its configuration especially tapering towards the tail. It is particularly susceptible to a problem known as “sink”. The particular core 28 used herein proportionally absorbs the heat from the molten lead from the tip of the nose to the tail and prevents this sink deformation from occurring.

Depending on the various lead alloys that are available, sometimes this technique alone will not solve the problem and cannonballs uses a technique described below. The core 28 is a rectangle shape with a hook 30 embedded on the top of it and it is pointed on the top side where it will encounter the flow of lead. The core 28 is wrapped in aluminium foil to shield it from the heat of the molten lead and it remains intact and again cools the centre and remains solid so the sink problem does not occur.

Referring to FIG. 10 and table 1 below a series of measurements are presented that give the actual dimensions of a representative version of a cannonball of the present invention. The measurements in table 1 are in centimeters. FIG. 10 represents the design of the shark cannonball of the present invention in three dimensions on the x,y,z axis. The diagram itself is two dimensions having a grid pattern of horizontal and vertical lines overlayed in increments of one centimetre. The intersecting lines represent points where measurements shown in table 1 were taken. One could therefore reconstruct an identical copy of the cannonball by using these same measurements. The distance from any intersecting point on one side of the model to the corresponding point on the other side of the model is the width of the model on the z axis at those points. All the slopes found in the design of the shark cannonball are described mathematically as measurements of the x,y,z axis. The model is symmetrical; one side of the model is a mirror image of the other side. The length of the vertical and horizontal lines on the two dimensional diagram determines the proportionality of the z axis.

TABLE 1

| | A | B | C | D | E | F | G | H | I | J |
|---|---|---|---|---|---|---|---|---|---|---|
| 1 | 0 | 0 | 0 | 0 | 0.7 | 1.3 | 1 | 0 | 0 | 0 |
| 2 | 0 | 0 | 0 | 0 | 1.5 | 2 | 1.8 | 0 | 0 | 0 |
| 3 | 0 | 0 | 0 | 1.4 | 2.2 | 2.6 | 2.2 | 1.4 | 0.7 | 0 |
| 4 | 0 | 0 | 1.1 | 2.1 | 2.8 | 3.1 | 2.6 | 2.2 | 1.4 | 0 |
| 5 | 0 | 0 | 1.7 | 2.8 | 3.3 | 3.4 | 3 | 2.7 | 2 | 0.8 |
| 6 | 0 | 1 | 2.2 | 3.2 | 3.7 | 3.7 | 3.5 | 3.2 | 2.5 | 1 |
| 7 | 0 | 1.4 | 2.1 | 3.6 | 4 | 4.1 | 4 | 3.6 | 2.8 | 1.2 |
| 8 | 0 | 1.8 | 3.1 | 3.8 | 4.2 | 4.3 | 4.2 | 3.8 | 3 | 1.6 |
| 9 | 0.7 | 2.3 | 3.4 | 4 | 4.3 | 4.3 | 4.3 | 3.9 | 3.2 | 1.7 |
| 10 | 1.1 | 2.4 | 3.6 | 4.1 | 4.3 | 4.5 | 4.3 | 4 | 3.3 | 1.7 |
| 11 | 1.3 | 2.6 | 3.6 | 4.2 | 4.3 | 4.5 | 4.3 | 4 | 3.3 | 1.7 |
| 12 | 1.3 | 2.6 | 3.6 | 4.2 | 4.3 | 4.5 | 4.3 | 4 | 3.3 | 1.7 |
| 13 | 1.3 | 2.2 | 3.4 | 4.1 | 4.3 | 4.4 | 4.3 | 3.8 | 3.1 | 1.6 |
| 14 | 1 | 2.3 | 3.3 | 4 | 4.3 | 4.3 | 4.3 | 3.7 | 2.9 | 1.4 |
| 15 | 0.4 | 1.9 | 3 | 3.8 | 4.1 | 4.2 | 4 | 3.6 | 2.7 | 1.2 |
| 16 | 0 | 1.3 | 2.7 | 3.5 | 3.9 | 4 | 3.7 | 3.2 | 2.4 | 0.9 |
| 17 | 0 | 0.8 | 2.2 | 3.2 | 3.7 | 3.6 | 3.4 | 3 | 2.1 | 0.5 |
| 18 | 0 | 0 | 1.6 | 2.8 | 3.4 | 3.4 | 3.22 | 2.7 | 1.6 | 0 |
| 19 | 0 | 0 | 0.5 | 2.2 | 2.8 | 3 | 2.7 | 2.4 | 1.1 | 0 |
| 20 | 0 | 0 | 0 | 1.5 | 2.1 | 2.6 | 2.4 | 1.8 | 0.4 | 0 |
| 21 | 0 | 0 | 0 | 0 | 1.8 | 2 | 1.8 | 1.1 | 0 | 0 |
| 22 | 0 | 0 | 0 | 0 | 0.6 | 1.5 | 1.3 | 0 | 0 | 0 |
| 23 | 0 | 0 | 0 | 0 | 0 | 0.5 | 0 | 0 | 0 | 0 |

The inventors have discovered that although the above technique works, it is also possible to manufacture the cannonball of the present invention without using a core.

As used herein, the terms “comprises” and “comprising” are to be construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

It will be appreciated that the above description related to the invention by way of example only. Many variations on the invention will be obvious to those skilled in the art and such obvious variations are within the scope of the invention as described herein whether or not expressly described.

1. A cannonball for use in association with downriggers comprising a generally egg shaped body having a front, a back, a center line, a top portion and a bottom portion wherein the slopes of the top portion from the center line to the front and back are greater than the slope of the bottom portion from the center line to the front and the back.

2. A cannonball as claimed in claim 1 wherein the slope of the top portion from the center line to the back is greater than the center line to the front and the slope of the bottom portion from the center line to the back is greater than the center line to the front.

3. A cannonball as claimed in claim 2 wherein the body has an outer surface that is a faceted surface.

4. A cannonball as claimed in claim 3 wherein the faceted surface includes a plurality of facets with each facet being concave.

5. A cannonball as claimed in claim 4 wherein each facet is asymmetrical.

6. A cannonball as claimed in claim 5 further including a mouth at the front of the body.

7. A cannonball as claimed in claim 6 wherein the mouth has a plurality of teeth.

8. A cannonball as claimed in claim 7 wherein the mouth has 36 teeth, 20 being in the top portion of the mouth and 16 being on the bottom.

9. A cannonball as claimed in claim 8 further including a tail.

10. A cannonball as claimed in claim 9 wherein the tail is one of 12 gauge stainless steel and 12 gauge brass.

11. A cannonball as claimed in claim 9 wherein the tall has a back edge and measures 10.3 cm along the back edge.

12. A cannonball as claimed in claim 11 wherein the tail protrudes generally 7.2 cm from a top-rear portion of the body and generally 9 cm from a bottom-rear portion of the body.

13. A cannonball as claimed in claim 12 wherein the tail has a top corner and edges and the tail has a ⅜″ hole in the top corner between 0.4 cm and 0.5 cm from the edges of the tail.

14. A cannonball as claimed in claim 1 wherein the cannonball is between 8 and 15 pounds in weight.

15. A cannonball as claimed in claim 13 wherein a hook extends outwardly from the top of the body.

16. A cannonball as claimed claim 13 further including a lead core.

17. A cannonball as claimed in claim 16 wherein the lead core is generally rectangular in shape.

18. A cannonball as claimed in claim 16 wherein a hook extends outwardly from the core and outwardly from the body.

19. A cannonball as claimed in claim 16 wherein the core is wrapped with aluminium.

20. A cannonball for use in association with downriggers comprising a body with a lead core therein.

21. A cannonball as claimed in claim 20 wherein the lead core is generally rectangular in shape.

22. A cannonball as claimed in claim 20 wherein a hook extends outwardly from the core and outwardly from the body.

23. A cannonball as claimed in claim 20 wherein the core is wrapped with aluminium.

24. A cannonball as claimed in claim 20 wherein the lead portion of the body measures 22.75 cm×8.75 cm×4.5 cm.

25. A cannonball as claimed in claim 24 further including a hook wire and steel tail and the entire body measures 26.4 cm×10.cm×4.5 cm.

26. A cannonball as claimed in claim 11 wherein the tail protrudes 9.2 cm from a top-rear portion of the body and 9 cm from a bottom-rear portion of the body.

27. A method of manufacturing cannonball for use in association with downriggers comprising the steps of
providing a cannonball mold having a top and a bottom;
pouring molten lead into the cannonball mold;
electroplating chrome onto the surface of the lead.

28. A method as claimed in claim 27 further including the step of forming a lead core and suspending it in the mold prior to pouring the molten lead and wherein the lead core is generally rectangular.

29. A method as claimed in claim 28 wherein a hook extends outwardly from the core and outwardly from the mold.

30. A method as claimed in claim 28 wherein the core is wrapped with aluminium.
